(19) United States
(12) Patent Application Publication
(10) Pub. No.: US 2015/0188761 A1
(43) Pub. Date: Jul. 2, 2015

(54) Method for Opening Network Connection of Display Device

(71) Applicant: Top Victory Investments Ltd., Kowloon (HK)

(72) Inventors: Mac CHUANG, New Taipei City (TW); Spancer LU, New Taipei City (TW)

(73) Assignee: Top Victory Investments Ltd., Kowloon (HK)

(21) Appl. No.: 14/144,715

(22) Filed: Dec. 31, 2013

(51) Int. Cl. H04L 12/24

(52) U.S. Cl. CPC H04L 41/0803; H04L 41/085

(57) ABSTRACT

A method for opening a network connection of a display device is provided, including: providing the display device having a setting interface for a user to set a relation between network contents and corresponding network connections and storing the relation in a lookup table; when the user controls the display device to activate a first network content, the display device automatically opening a first network connection according to the lookup table to transmit the first network content to display without manually opening the first network connection, resulting in more convenience in use; and, when the display device displays the first network content and the user controls the display device to activate a second network content, the display device automatically opening a second network connection according to the lookup table to transmit the second network content to display without manually opening the second network connection, resulting in more convenience in use.

### BACKGROUND OF THE INVENTION

1. Field of the Invention

The invention relates to a method for opening a network connection of an electronic device. More particularly, the invention relates to a method for opening a network connection of a display device.

2. Description of the Related Art

If a conventional display device having network functions wants to receive a network content from an external source in a network transmission manner, it needs to open a network connection for transmitting the network content at first. For example, when a user wants to view a first network content, the user needs to control the display device to open a first network connection for transmitting the first network content, and then control the display device to receive the first network content from the external source via the first network connection to activate the display of the first network content. Furthermore, when the user wants to change to view a second network content which needs to be transmitted via a second network connection different from the first network connection, the user needs to control the display device to open the second network connection for transmitting the second network content, and then control the display device to receive the second network content from the external source via the second network connection to activate the display of the second network content.

Therefore, when the user wants to control the display device to activate to display a specific network content, the user needs to manually open a specific network connection for transmitting the specific network content, and then manually activate the display of the specific network content. That is, the network connection and the network content are irrelevant to each other in the display device. In fact, the method for opening the network connection of the display device irrelevant to the network content follows that of a personal computer (PC). However, as sources of network contents become more and more, types of network connections for transmitting the network contents become more and more, so that the method for manually opening the network connection of the display device results in more inconvenience in use.

### SUMMARY OF THE INVENTION

The invention is adapted to providing a method for opening a network connection of a display device. When a user controls the display device to activate to display a specific network content, the display device may automatically open a specific network connection for transmitting the specific network content without manually opening the specific network connection.

According to an aspect of the invention, there is provided a method for opening a network connection of a display device. The method comprises: providing the display device having a setting interface for a user to set a relation between a plurality of network contents and a plurality of corresponding network connections and storing the relation in a lookup table, wherein the plurality of network connections comprise a first network connection and a second network connection different from the first network connection, and the plurality of network contents comprise a first network content transmitted via the first network connection and a second network content transmitted via the second network connection; when the user controls the display device to activate the first network content, the display device automatically opening the first network connection according to the lookup table to transmit the first network content, and displaying the first network content; and, when the display device displays the first network content and the user controls the display device to activate the second network content, the display device automatically opening the second network connection according to the lookup table to transmit the second network content, and displaying the second network content.

According to another aspect of the invention, the display device is a television or a computer monitor.

According to another aspect of the invention, the display device is a smart display device.

According to another aspect of the invention, the first network content or the second network content comes from a set-top box (STB), a video game console, a video player, a digital living network alliance (DLNA) device, a smart phone, another display device, a computer, or a network interface controller (NIC).

According to another aspect of the invention, the first network connection or the second network connection is a wired network connection or a wireless network connection.

According to another aspect of the invention, the lookup table comprises a plurality of sets of settings, and each set of settings comprises a name of the network content, a name of the corresponding network connection, a network protocol, a band, a security mode, a user name, a password, and a transmission bandwidth.

According to another aspect of the invention, the first network content and the second network content are different.

According to another aspect of the invention, the first network content and the second network content are the same.

According to another aspect of the invention, the method further comprises: when the display device displays the first network content and the user controls the display device to activate the second network content, the display device further automatically closing the first network connection.

According to another aspect of the invention, the user controls the display device to activate the first network content or the second network content by switching from a video source to another video source of the display device or running an application installed in the display device.

It is remarked that the above mentioned aspects or features can also be combined with each other and are in the scope of the invention as well.

By establishing the lookup table including the relation between the network contents and the network connections for transmitting the network contents, when the user controls the display device to activate to display a specific network content, the display device may automatically open, according the lookup table, a specific network connection for transmitting the specific network content without manually opening the specific network connection, resulting in more convenience in use. In addition, when the display device automatically opens a new network connection, it may automatically close the last-opened network connection to save power.

### BRIEF DESCRIPTION OF THE DRAWINGS

The invention will be described in further detail below under reference to the accompanying drawings, in which:

FIG. 1 is a flowchart of a method for opening a network connection of a display device according to a preferred embodiment of the invention.

### DETAILED DESCRIPTION OF THE INVENTION

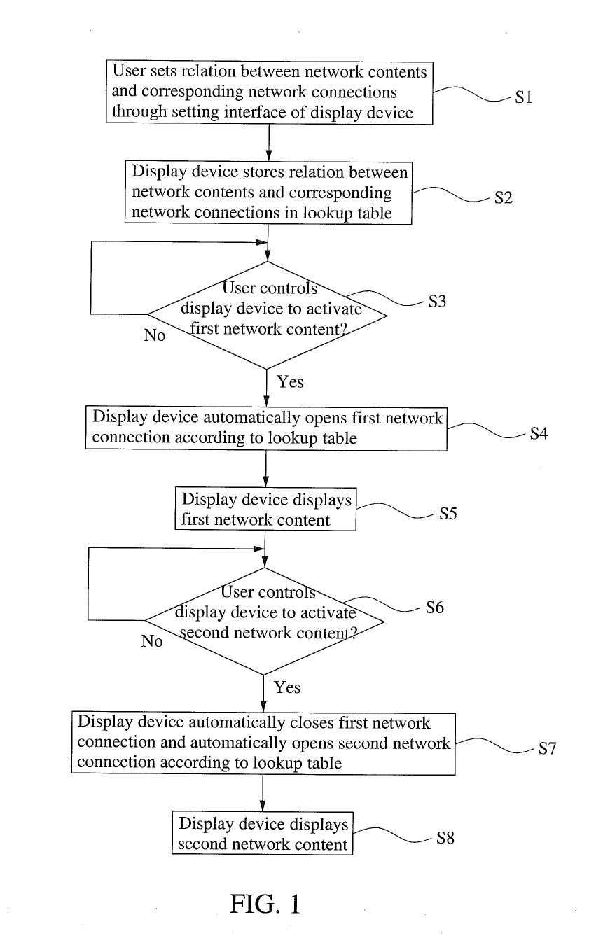

Referring to FIG. 1, there is shown a flowchart of a method for opening a network connection of a display device according to a preferred embodiment of the invention. In step S1, a user sets a relation between network contents and corresponding network connections through a setting interface provided by the display device having network functions. In the embodiment, the display device may be a television, a computer monitor, or other type of display device, and the display device may be a general display device or a smart display device having an operating system or applications installed therein. The network content may come from a STB, a video game console (e.g., an XBOX console), a video player (e.g., a DVD player), a DLNA device (e.g., a PlayStation 3 console), a smart phone, another display device, a computer, a NIC, or other electronic device capable of communicating with the display device through network transmission. The network connection may be any type of wired network connection or any type of wireless network connection.

In step S2, the display device stores the relation between the network contents and the corresponding network connections set by the user in a lookup table. In the embodiment, the lookup table includes sets of settings, and each set of settings includes a name of the network content, a name of the corresponding network connection, a network protocol, a band, a security mode, a user name, a password, and a transmission bandwidth. It is assumed that, in the display device, there are two different network contents and two corresponding different network connections. For example, the display device has a wireless network interface capable of communicating with a wireless access point (WAP) named AP1 provided by a STB through a first network connection (e.g., using IEEE 802.11 wireless network protocol) to transmit a first network content (e.g., a digital television program obtained through the STB via a cable); moreover, the display device has a wired network interface capable of communicating with a local area network named LAN1 through a second network connection (e.g., using IEEE 802.3 wired Ethernet standard) to transmit a second network content (e.g., YouTube website connected through the local area network).

Therefore, there are two sets of settings stored in the lookup table, in which: the first set of settings includes a name (e.g., digital television) of the first network content, a name (e.g., AP1) of the first network connection, a network protocol (i.e., IEEE 802.11), a band (i.e., 2.4 G), a security mode (e.g., WEP), a user name (e.g., spancer), a password (e.g., 123456), and a transmission bandwidth (e.g., 20 MB); and, the second set of settings includes a name (e.g., YouTube) of the second network content, a name (e.g., LAN1) of the second network connection, a network protocol (i.e., IEEE 802.3), a band (i.e., none), a security mode (e.g., none), a user name (e.g., ISP user name, T154687), a password (e.g., ISP password, qwert), and a transmission bandwidth (e.g., 8 MB).

In step S3, during the normal operation of the display device, when the user doesn't control the display device to activate any network content, the display device doesn't open any network connection. When the user controls the display device to activate the first network content by, for example, using an on-screen display (OSD) menu to switch from a video source to another video source of the display device, the method goes to step S4. In step S4, the display device automatically opens the first network connection according to the lookup table to transmit the first network content, and then the method goes to step S5. In step S5, the display device displays the first network content (i.e., the digital television program).

In step S6, when the display device displays the first network content and the user doesn't control the display device to activate the second network content, the method goes back to step S5, so that the display device keeps on displaying the first network content. When the display device displays the first network content and the user controls the display device to activate the second network content by, for example, running an application (e.g. a web browser) installed in the display device, the method goes to step S7. In step S7, the display device automatically closes the first network connection, and automatically opens the second network connection according to the lookup table to transmit the second network content, and then the method goes to step S8. In step S8, the display device displays the second network content (i.e., YouTube website).

Although in the above-mentioned embodiment the first network content and the second network content are different, and the first network connection and the second network connection are also different, the invention is not limited to the above-mentioned embodiment. For example, the first network content and the second network content may be the same. When the first network content and the second network content are the same, and the first network connection and the second network connection are different, if the user views the first network content transmitted via the first network connection and finds the connection quality of the first network connection poor, he or she may change to the second network connection having better connection quality to view the second network content (being the same as the first network content) transmitted via the second network connection.

By establishing the lookup table including the relation between the network contents and the network connections for transmitting the network contents, when the user controls the display device to activate to display a specific network content, the display device may automatically open, according the lookup table, a specific network connection for transmitting the specific network content without manually opening the specific network connection, resulting in more convenience in use. In addition, when the display device automatically opens a new network connection, it may automatically close the last-opened network connection to save power.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for opening a network connection of a display device, comprising:
providing the display device having a setting interface for a user to set a relation between a plurality of network contents and a plurality of corresponding network connections and storing the relation in a lookup table, wherein the plurality of network connections comprise a first network connection and a second network connection different from the first network connection, and the plurality of network contents comprise a first network content transmitted via the first network connection and a second network content transmitted via the second network connection;
when the user controls the display device to activate the first network content, the display device automatically opening the first network connection according to the lookup table to transmit the first network content, and displaying the first network content; and
when the display device displays the first network content and the user controls the display device to activate the second network content, the display device automatically opening the second network connection according to the lookup table to transmit the second network content, and displaying the second network content.

2. The method of claim 1, wherein the display device is a television or a computer monitor.

3. The method of claim 1, wherein the display device is a smart display device.

4. The method of claim 1, wherein the first network content or the second network content comes from a set-top box (STB), a video game console, a video player, a digital living network alliance (DLNA) device, a smart phone, another display device, a computer, or a network interface controller (NIC).

5. The method of claim 1, wherein the first network connection or the second network connection is a wired network connection or a wireless network connection.

6. The method of claim 1, wherein the lookup table comprises a plurality of sets of settings, and each set of settings comprises a name of the network content, a name of the corresponding network connection, a network protocol, a band, a security mode, a user name, a password, and a transmission bandwidth.

7. The method of claim 1, wherein the first network content and the second network content are different.

8. The method of claim 1, wherein the first network content and the second network content are the same.

9. The method of claim 1, further comprising: when the display device displays the first network content and the user controls the display device to activate the second network content, the display device further automatically closing the first network connection.

10. The method of claim 1, wherein the user controls the display device to activate the first network content or the second network content by switching from a video source to another video source of the display device or running an application installed in the display device.
